(19) United States
(12) Patent Application Publication
(10) Pub. No.: US 2009/0225175 A1
(43) Pub. Date: Sep. 10, 2009

(54) DRIVE DEVICE

(75) Inventor: Yukio Uenaka, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/397,370

(22) Filed: Mar. 4, 2009

(30) Foreign Application Priority Data
Mar. 6, 2008 (JP) 2008-056206

(51) Int. Cl. H04N 5/228; G03B 17/02; B08B 11/00; G03B 17/00; H04N 5/225

(52) U.S. Cl. 348/208.11; 396/439; 15/89; 396/55; 348/374; 348/E05.031; 348/E05.024

(57) ABSTRACT

A drive device is provided having a movable part, a first drive part, and a second drive part. The movable part is swingable relative to a fixed part. The first drive part drives the movable part in a first direction. The second drive part drives the movable part in a direction opposite to the first direction. The fixed part has bumpers which are struck by the movable part. The first and second drive parts simultaneously drive said movable part so as to strike the bumpers.

### BACKGROUND OF THE INVENTION

1. Field of the Invention

The present invention relates to a drive device that drives a movable part on which, for example, a camera's image sensor is attached.

2. Description of the Related Art

A device which is provided in a photographing device such as a digital camera and removes dust particles attached to the camera's image sensor and its cover is proposed.

United States Published Patent Application Publication Number 2005-0264656 A discloses a drive device which strikes a movable part against a fixed part so as to remove dust particles attached to an image sensor and its cover by the impact of the strike.

However, the simple impact of striking a movable part against a fixed part causes a large shock to the drive device. It may disturb the user and could damage the drive device.

### SUMMARY OF THE INVENTION

An object of the present invention is to provide a drive device which performs with low shock in a drive device.

A drive device is provided having a movable part, a first drive part, and a second drive part. The movable part is swingable relative to the fixed part. The first drive part drives the movable part in a first direction. The second drive part drives the movable part in a direction opposite the first direction. The fixed part has bumpers which are struck by the movable part. The first and second drive parts simultaneously drive said movable part so as to strike the bumpers.

### BRIEF DESCRIPTION OF THE DRAWINGS

The objects and advantages of the present invention will be better understood from the following description, with reference to the accompanying drawings in which:

FIG. 1 is a perspective view of the image-capturing device in to the embodiment of the present invention;

FIG. 2 is a front view of the image-capturing device;

FIG. 3 is a block diagram of the image-capturing device;

FIG. 4 is a flowchart showing a main process of the image-capturing device;

FIG. 5 is a flowchart showing an interruption process;

FIG. 6 is a flowchart showing a dust-removal process;

FIG. 7 shows the trajectory of the movable part in the y-direction during the dust-removal process;

FIG. 8 schematically shows the trajectory of the movable part as viewed from the LCD monitor side;

FIG. 9 also schematically shows the trajectory of the movable part as viewed from the LCD monitor side; and

FIG. 10 shows the trajectory of the movable part in the x-direction during the dust-removal process.

### DESCRIPTION OF THE PREFERRED EMBODIMENTS

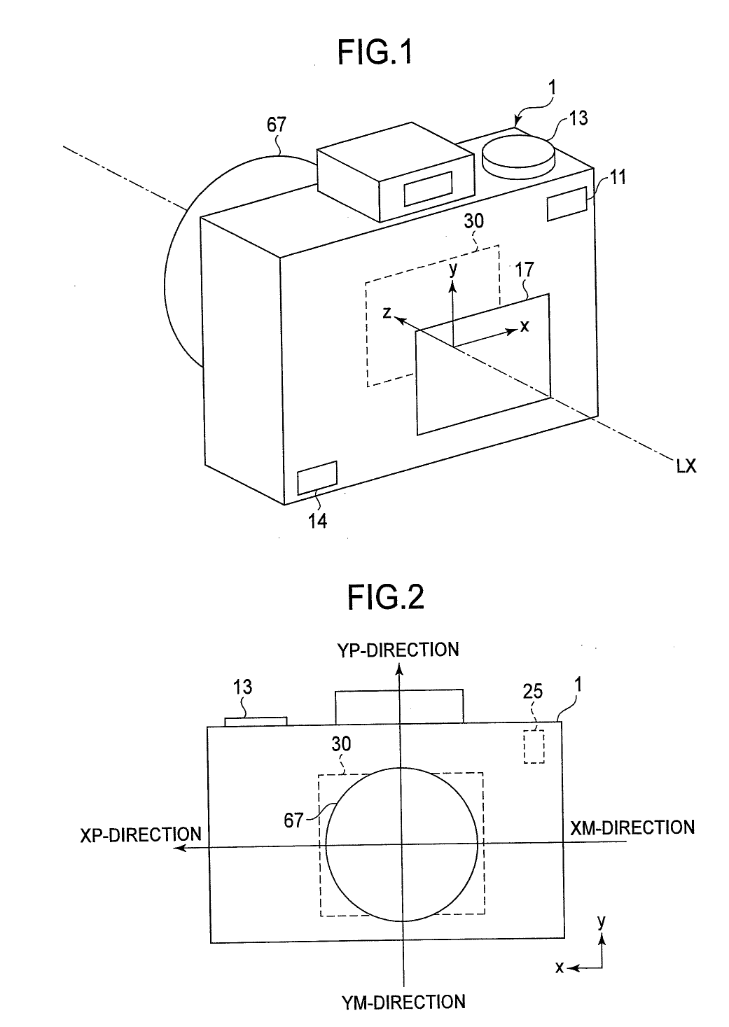

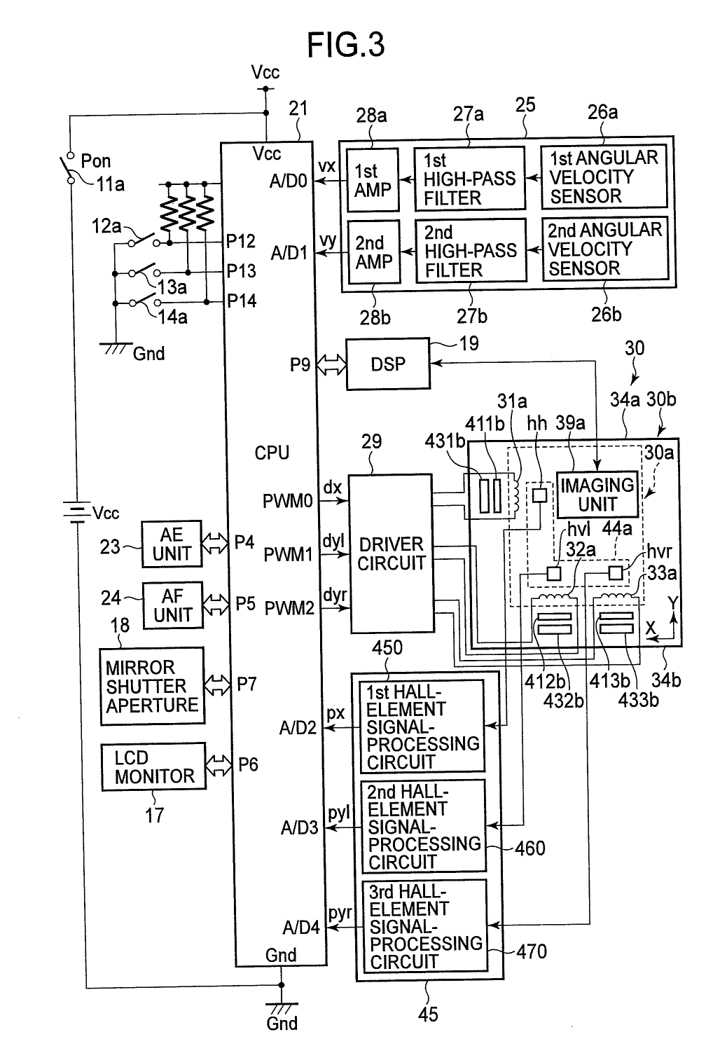

The present invention is described below with reference to the embodiment shown in the drawings. FIGS. 1 to 3 show the construction of an image-capturing apparatus 1 which comprises a drive device according to the present embodiment. In this embodiment, the photographing apparatus 1 is a digital camera. A photographing optical system, such as a camera lens 67 etc., that captures an optical image on a photographing surface of the image sensor of the photographing apparatus 1 has an optical axis LX. In order to explain the orientation of the embodiment, an x-direction (the first direction), a y-direction (the second direction), and a z-direction are defined (refer to FIG. 1). The x-direction is in the horizontal plane and perpendicular to the optical axis LX. The y-direction is perpendicular to the optical axis LX and the x-direction. The z-direction is parallel to the optical axis LX and perpendicular to both the x-direction and the y-direction.

The photographing apparatus 1 comprises a power button 11 which is used to turn on or off the power of the photographing apparatus, a release button 13, an anti-shake button 14, an LCD monitor 17, a mirror-aperture-shutter unit 18, a DSP 19, a CPU 21, an AE (automatic exposure) unit 23, an AF (automatic focus) unit 24, an anti-shake unit 30, imaging unit 39a, and a camera lens 67. These components perform the imaging function.

Whether the power switch 11a is in the ON state or the OFF state is determined by the state of the power button 11, so that the ON and OFF states of the photographing apparatus 1 correspond to the ON and OFF states of the power switch 11a. The photographic subject image is captured as an optical image through the camera lens 67 by the imaging unit 39a, and the captured image is displayed on the LCD monitor 17. The photographic subject image can be observed through the optical finder (not depicted).

After the power button 11 is depressed, putting the photographing apparatus 1 in the ON state, a dust-removal operation is performed in a first period (220 ms).

When the release button 13 is partially depressed by the operator, the photometric switch 12a changes to the ON state so that the photometric operation, the AF-sensing operation, and the focusing operation are performed. When the release button 13 is fully depressed by the operator, the release switch 13a changes to the ON state so that the imaging operation by the imaging unit 39a (the imaging apparatus) is performed, and the image is captured and stored.

The mirror-aperture-shutter unit 18 is connected to port P7 of the CPU 21 and performs an UP/DOWN operation of the mirror (a mirror-up operation and a mirror-down operation), an OPEN/CLOSE operation of the aperture, and an OPEN/CLOSE operation of the shutter according to the ON state of the release switch 13a.

The DSP 19 is connected to the imaging unit 39, and port P9 of the CPU 21. Based on a command from the CPU 21, the DSP 19 performs calculations such as image processing, etc., on the image signal obtained by the imaging operation of the imaging unit 39a.

The CPU 21 is a control apparatus that controls each part of the photographing apparatus 1 regarding the imaging operation, the dust-removal operation, and the anti-shake operation (i.e., the image stabilizing operation). The anti-shake operation includes both the movement of the movable part 30a and a position-detection operation. Furthermore, the CPU 21 stores the value of anti-shake parameter IS, the value of release state parameter RP, the value of dust-removal state parameter GP, and the value of dust-removal time parameter CNT.

Anti-shake parameter IS indicates whether the photographing apparatus 1 is in the anti-shake mode. When the anti-shake parameter IS equals one, the photographing apparatus 1 is in the anti-shake mode; when it equals zero, the photographing apparatus 1 is not in the anti-shake mode.

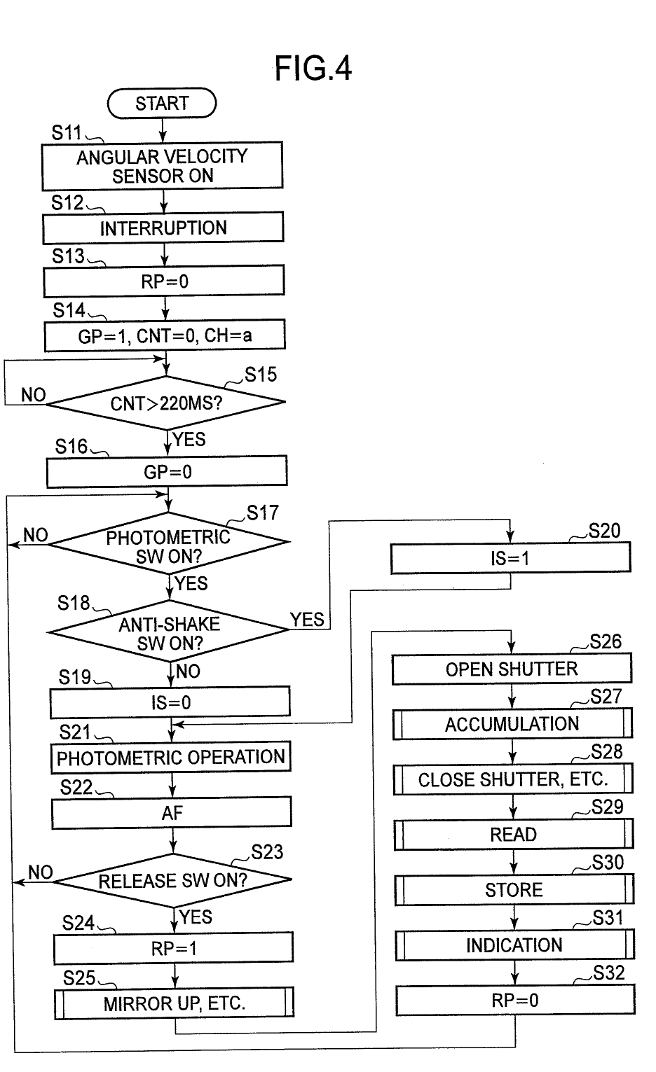

The value of the release state parameter RP changes with respect to the release sequence operation. When the release sequence operation is performed, the value of the release state parameter RP is set to one (refer to steps S24 to S31 in FIG. 4); and when the release sequence operation is finished, the value of the release state parameter RP is set (reset) to zero (refer to steps S13 and S32 in FIG. 4).

The dust-removal state parameter GP indicates whether the dust-removal operation is finished. The value of the dust-removal state parameter GP is set to one because the dust-removal operation may be considered underway from the moment immediately after the photographing apparatus 1 is set to the ON state until the first period (220 ms) has elapsed (refer to step S14 in FIG. 4).

The value of the dust-removal state parameter GP is set to zero because the dust-removal operation may be considered to be finished from the moment when the first period (220 ms) has elapsed after the photographing apparatus 1 is set to the ON state (refer to step S16 in FIG. 4).

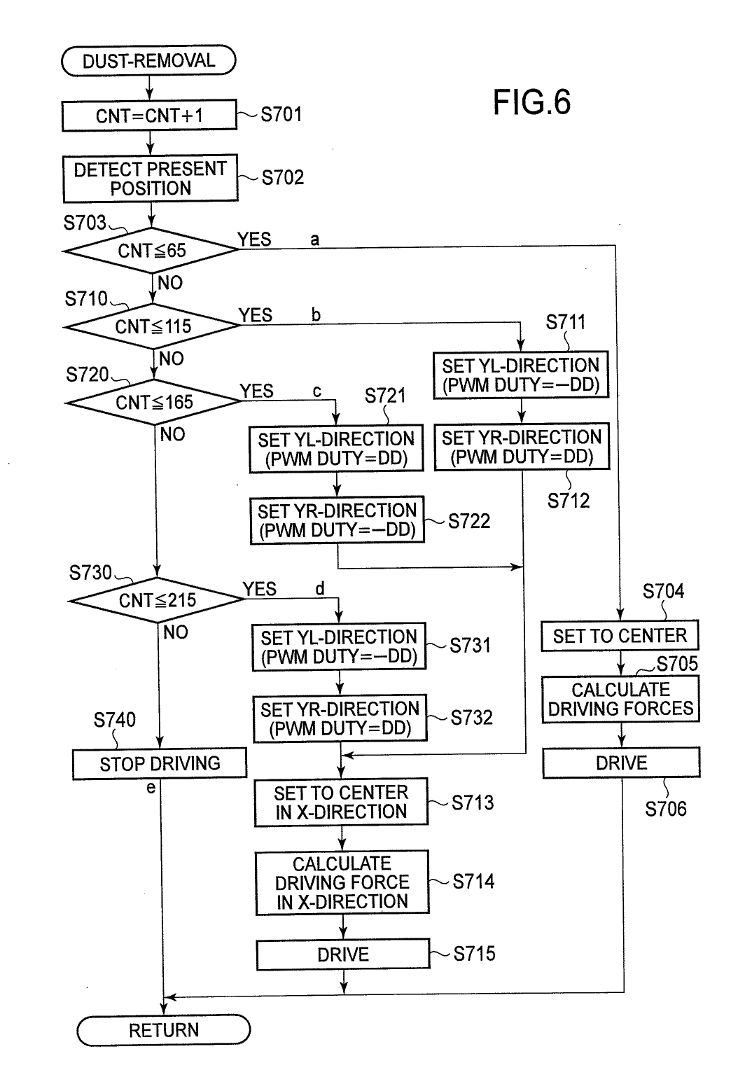

The dust-removal time parameter CNT is used for measuring the length of time the dust-removal operation is underway. The initial value of the dust-removal time parameter CNT is substituted by zero. While the dust-removal operation is being performed, the value of the dust-removal time parameter CNT is increased by one at every time interval of 1 ms (refer to step S701 in FIG. 6).

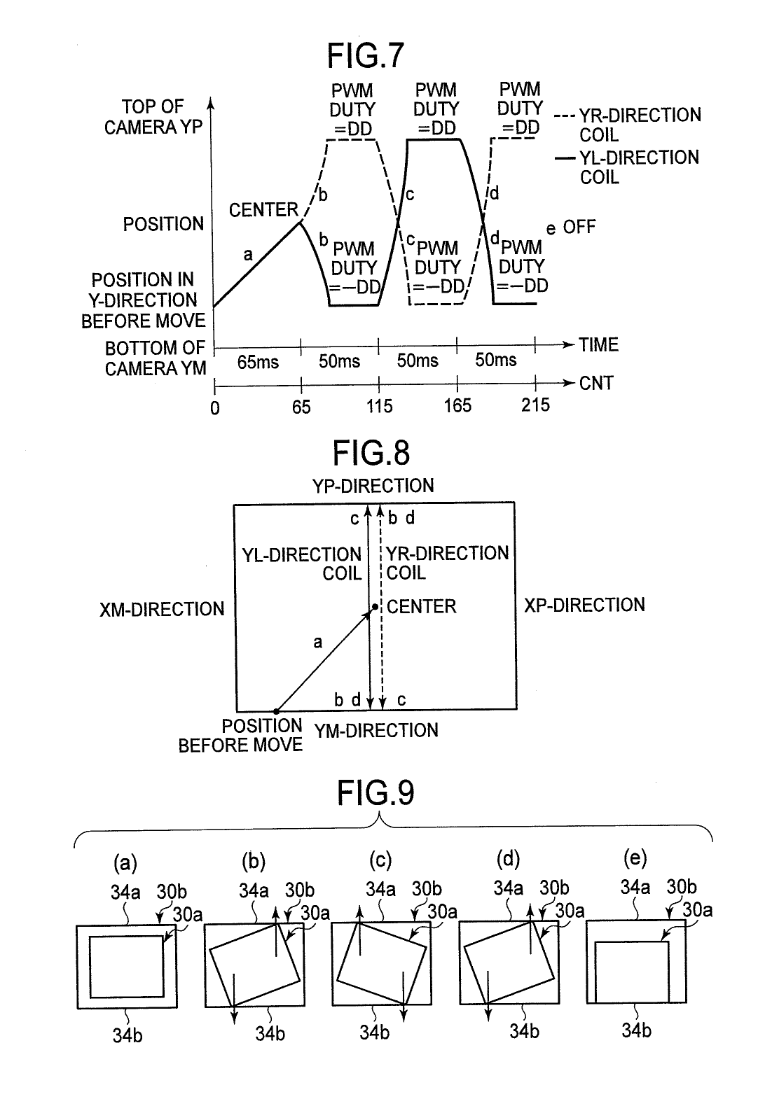

The CPU 21 moves the movable part 30a to a predetermined initial position in the dust-removal operation before the anti-shake operation. This operation is named the centering operation (refer to step S84 in FIG. 7). In this embodiment, the predetermined position is the center of the movement range (where the coordinate values in the x-direction and in the y-direction are both 0).

Then, the center of mass of the movable part 30a is kept at a certain position relative to the x-direction by the CPU 21. The XP-side of the movable part 30a is driven in the YP-direction of the y-direction, and the XM-side of the movable part 30a is driven in the YM-direction at the same time. Therefore, the movable part 30a swings relative to a given axis, so that the XP-end of the YP-side of the movable part 30a strikes the upper boundary 34a of the movable range and the XM-end of the YM-side of the movable part 30a strikes the lower boundary 34b of the movable range.

Then, the XP-side of the movable part 30a is driven in the YM-direction of the y-direction, and the XM-side is simultaneously driven in the YP-direction, while the movable part 30a is kept at a certain position concerning to the x-direction. Therefore, the movable part 30a swings in the direction opposite to last swing, so that the XM-end of the YP-side strikes the upper boundary 34a of the movable range and the XP-end of the YM-side strikes the lower boundary 34b of the movable range. After repeating these processes, the dust-removal operation ends.

The dust particles on the imaging unit 39a of the movable part 30a (the image sensor and the low-pass filter) are removed by the shock of the impact of the movable part 30a against the boundary of said movable range. After the dust-removal operation is completed, the anti-shake operation begins.

Next, the CPU 21 stores the values of a first digital angular velocity signal Vxn, a second digital angular velocity signal Vyn, a first digital angular velocity VVxn, a second digital angular velocity VVyn, a first digital displacement angle Bxn, a second digital displacement angle Byn, the coordinate of position Sn in the x-direction, Sxn; the coordinate of position Sn in the y-direction, Syn; the first driving force, Dxn; the second driving force, Dyn; the coordinate of position Pn after A/D conversion in the x-direction, pdxn; the coordinate of position Pn after A/D conversion in the y-direction, pdyn; a first subtraction value, exn; a second subtraction value, eyn; a first proportional coefficient, Kx; a second proportional coefficient, Ky; a sampling cycle θ of the anti-shake operation; a first integral coefficient, Tix; a second integral coefficient, Tiy; a first differential coefficient, Tdx; and a second differential coefficient, Tdy.

The AE unit 23 (an exposure calculating unit) performs the photometric operation and calculates the photometric values, based on the subject being photographed. The AE unit 23 also calculates the aperture value and the duration of the exposure, with respect to the photometric values, both of which are needed for imaging. The AF unit 24 performs the AF-sensing operation and the corresponding focusing operation, both of which are also needed for imaging. In the focusing operation, the camera lens 67 is moved along the optical axis LX.

The anti-shake part (the anti-shake apparatus) of the photographing apparatus 1 comprises an anti-shake button 14, an anti-shake switch 14a, an LCD monitor 17, a CPU 21, an angular velocity detection unit 25, a driver circuit 29, an anti-shake unit 30, a hall-element signal-processing unit 45 (a magnetic-field change-detecting element), and the camera lens 67.

When the anti-shake button 14 is depressed by the operator, the anti-shake switch 14a is set to the ON state. When the anti-shake switch 14a is in the ON state, the photographing apparatus 1 is in the anti-shake mode, and the anti-shake parameter IS is set to one (IS=1). When the anti-shake switch 14a is not in the ON state, the photographing apparatus 1 is in the non-anti-shake mode, and the anti-shake parameter IS is set to zero (IS=0). In the anti-shake mode, the anti-shake operation is executed. In the anti-shake operation, the angular velocity detection unit 25 and the anti-shake unit 30 are driven for the second period, independent of other operations, such as the photometry operation. In this embodiment, the value of the predetermined time interval is set to 1 ms.

The CPU 21 controls the various output commands corresponding to the input signals from these switches. The port P12 of the CPU 21 receives a 1-bit digital signal indicating whether the photometric switch 12a is in the ON state or the OFF state. The port P13 of the CPU 21 receives a 1-bit digital signal indicating whether the release switch 13a is in the ON state or the OFF state. The port P14 of the CPU 21 receives a 1-bit digital signal indicating whether the anti-shake switch 14a is in the ON state or the OFF state. The AE unit 23, the AF unit 24, and the LCD monitor 17 are respectively connected to port P4, P5 and P6 of the CPU 21 for I/O.

Next, the details of the angular velocity detection unit 25, the driver circuit 29, the anti-shake unit 30, and the hall-element signal-processing unit 45 are described.

The angular velocity detection unit 25 has a first angular velocity sensor 26a, a second angular velocity sensor 26b, a first high-pass filter circuit 27a, a second high-pass filter circuit 27b, a first amplifier 28a and a second amplifier 28b.

The first angular velocity sensor 26a detects the angular velocity of a rotary motion (the yawing) of the photographing apparatus 1 about the axis of the y-direction, i.e., it detects the velocity component in the x-direction of the angular velocity of the photographing apparatus 1. The first angular velocity sensor 26a is a gyro sensor that detects the yaw angular velocity.

The second angular velocity sensor 26b detects the angular velocity of a rotary motion (the pitch) of the photographing apparatus 1 about the axis of the x-direction i.e., detects the velocity component in the y-direction of the angular velocity of the photographing apparatus 1. The second angular velocity sensor 26b is a gyro sensor that detects a pitch angular velocity.

The first high-pass filter circuit 27a reduces a low-frequency component of the signal output from the first angular velocity sensor 26a, because the low-frequency component of the signal output from the first angular velocity sensor 26a includes signal elements that are based on a null voltage and panning motion, neither of which are related to camera shake. The second high-pass filter circuit 27b reduces a low-frequency component of the signal output from the second angular velocity sensor 26b, because the low-frequency component of the signal output from the second angular velocity sensor 26b includes signal elements that are based on a null voltage and panning motion, neither of which are related to camera shake. The processes performed by the first and second high-pass filter circuit 27a and 27b are analog high-pass filter processes.

The first amplifier 28a amplifies a signal related to the yawing angular velocity, whose low-frequency component has been reduced, and outputs the analog signal to the port A/DO of the CPU 21 as a first angular velocity vx. The second amplifier 28b amplifies a signal relating to the pitch angular velocity, whose low-frequency component has been reduced, and outputs the analog signal to the port A/D1 of the CPU 21 as a second angular velocity vy.

The reduction of the low-frequency signal component is a two-step process; the primary part of the analog high-pass filter process is performed first by the first and second high-pass filter circuits 27a and 27b, followed by the secondary part of the digital high-pass filter process that is performed by the CPU 21. The cut-off frequency of the secondary part of the digital high-pass filter process is higher than that of the primary part of the analog high-pass filter process. In the digital high-pass filter process, the value of a time constant (a first high-pass filter time constant hx and a second high-pass filter time constant hy) can be easily changed.

The supply of electrical power to the CPU 21 and all parts of the angular velocity detection unit 25 begins after the power switch 11a is set to the ON state (i.e., the main power supply is set to the ON state). The calculation of a camera-shake value begins after the power switch 11a is set to the ON state and the dust-removal operation is finished.

The CPU 21 converts the first and second angular velocities vx and vy, which are respectively input to the ports A/D0 and A/D1, to a first and second digital angular velocity signals Vxn and Vyn. It then calculates first and second digital angular velocities VVxn and VVyn by reducing a low-frequency component of the first and second digital angular velocity signals Vxn and Vyn (the digital high-pass filter process) because the low-frequency component of the first and second digital angular velocity signals Vxn and Vyn include signal elements that are based on a null voltage and panning motion, neither of which are related to camera shake. Moreover, it calculates a camera-shake displacement angle (the first and second digital displacement angles Bxn and Byn) by integrating the first and second digital angular velocities VVxn and VVyn (the integration process).

The CPU 21 and the angular velocity detection unit 25 use a function to calculate the camera-shake value.

“n” is an integer greater than zero and indicates the length of time (ms) from the commencement of the timer interruption process, (t=0; refer to step S12 in FIG. 4), to the point when the latest anti-shake operation is performed (t=n).

In the digital high-pass filter process regarding the x-direction, the first digital angular velocity VVxn is calculated by dividing the summation of the first digital angular velocities VVx0 to VVxn−1 (calculated by the timer interruption process before the 1 ms predetermined time interval; i.e., before the latest anti-shake operation was performed), by the first high-pass filter time constant hx, and then subtracting the resulting quotient from the first digital angular velocity signal Vxn (VVxn=Vxn−(ΣVVxn−1)÷hx). In the digital high-pass filter process regarding the y-direction, the second digital angular velocity VVyn is calculated analogously to VVxn to give(VVyn=Vyn−(ΣVVyn−1)÷hy).

In this embodiment, the angular velocity detection operation in (a portion of) the timer interruption process includes the processing by the angular velocity detection unit 25 and the process of inputting the first and second angular velocities vx and vy from the angular velocity detection unit 25 to the CPU 21.

In the integration process regarding the x-direction, the first digital displacement angle Bxn is calculated by summing from the first digital angular velocity VVx0 at the point when the timer interruption process commences (t=0; refer to step S12 in FIG. 4), to the first digital angular velocity VVxn at the point when the latest anti-shake operation is performed (t=n; Bxn=ΣVVxn).

Similarly, in the integration process regarding the y-direction, the second digital displacement angle Byn is calculated by summing from the second digital angular velocity VVy0 at the point when the timer interruption process commences, to the second digital angular velocity VVyn at the point when the latest anti-shake operation is performed (Byn=ΣVVyn).

The CPU 21 calculates the position Sn where the imaging unit 39a (the movable part 30a) should be moved, corresponding to the camera-shake value (the first and second digital displacement angles Bxn and Byn) that is calculated for the x-direction and the y-direction on the basis of a position conversion coefficient zz (a first position conversion coefficient zx for the x-direction and a second position conversion coefficient zy for the y-direction).

The coordinate of position Sn in the x-direction is defined as Sxn, and in the y-direction as Syn. The movement of the movable part 30a, which includes the imaging unit 39a, is performed using electromagnetic force, and is described later.

The driving force Dn drives the driver circuit 29 in order to move the movable part 30a to the position Sn. The coordinate of the driving force Dn in the x-direction is defined as the first driving force Dxn (after D/A conversion: a first PWM duty dx). The coordinate of the driving force Dn in the y-direction is defined as the second driving force Dyn (after D/A conversion: a second PWM duty dy). A first driving coil 31a is driven according to the value of the first driving force Dxn. A second driving coil 32a and a third driving coil 33a are driven according to the second driving force Dyn, i.e., they are driven by the same force value.

The first PWM duty dx is the duty ratio of the driving pulse corresponding to the first driving force Dxn. The second PWM duty dyl and the third PWM duty dyr are the duty ratio of the driving pulse corresponding to the second driving force Dyn. In the dust-removal operation, the second PWM duty dyl is the same as the third PWM duty dyr.

The value of second driving force Dyn is represented by +DD or −DD. +DD indicates that the movable part 30a is driven in the positive y-direction (YP-direction), i.e., towards the upper end of the fixed part 30b. −DD indicates that the movable part 30a is driven in the negative y-direction (YM-direction), i.e., towards the bottom end of the fixed part 30b.

However, the position Sn, where the imaging unit 39a (the movable part 30a) should be moved in the first period (220 ms) for the dust-removal operation before the anti-shake operation is performed, is set to “a” value that does not correspond to the camera-shake value (refer to step S704 in FIG. 6).

For example, the position Sn is set as the center of the fixed part 30b in the “a” trajectory of the dust-removal operation. Therefore, the movable part 30a is set at the center of the fixed part 30b. In the “b” to “d” trajectories of the dust-removal operation, the x-direction component of the position Sn is set to a certain value, but in the y-direction, only the PWM duty is set and the y-direction component of the position Sn is not set. Thus, the movable part 30a is moved towards the top or bottom of the fixed part 30b by constant force, and strikes it.

In a positioning operation along the x-direction, the coordinate of position Sn in the x-direction is defined as Sxn, and is the product of the latest first digital displacement angle Bxn and the first position conversion coefficient zx (Sxn=zx×Bxn).

In a positioning operation along the y-direction, the coordinate of position Sn in the y-direction is defined as Syn, and is the product of the latest second digital displacement angle Byn and the second position conversion coefficient zy (Syn=zy×Byn).

The anti-shake unit 30 corrects for camera shake by repeatedly moving the imaging unit 39a to position Sn. This stabilizes the photographing subject image displayed on the imaging surface of the image sensor during the exposure time when the anti-shake operation is performed (IS=1).

The anti-shake unit 30 has a fixed part 30b that forms the boundary of the movement range of the movable part 30a, and the movable part 30a which includes the imaging unit 39a and can be moved on the xy plane. The movement range is wider than the shake-correction area in which the movable part 30a is moved during the anti-shake operation.

During the exposure time when the anti-shake operation is not performed (IS=0), the movable part 30a is held in the predetermined position. The predetermined position is the center of the movement range.

In the first period (220 ms), after the photographing apparatus 1 is set to the ON state, the movable part 30a is driven to the predetermined position (i.e., the center of the movement range). Next, the movable part 30a is driven against the boundary of the movement range in the y-direction.

Otherwise (except for the first period and the exposure time), the movable part 30a is not driven.

The anti-shake unit 30 does not have a fixed-positioning mechanism that maintains it in a fixed position when it is not being driven (i.e., the drive OFF state).

The driving of the movable part 30a of the anti-shake unit 30, including the movement to a predetermined fixed position, is performed by the electromagnetic force of the coil and magnetic units for driving, by action of the driver circuit 29 which has first PWM duty dx input from the PWM0 of the CPU 21 and second PWM duty dy input from the PWM1 of the CPU 21.

The movable part 30a of the anti-shake unit 30 is driven by electromagnetic force created by the coil and magnet units. The electromagnetic force is generated when the driver circuit 29 energizes the coil units. The driver circuit 29 energizes a first driving coil 31a when receiving first PWM duty dx output by the PWM0 of the CPU 21, a second driving coil 32a when receiving second PWM duty dyl output by the PWM1, and a third driving coil 33a when receiving third PWM duty dyr output by the PWM2.

The position Pn of the movable part 30a, either before or after the movement effected by the driver circuit 29, is detected by the hall element 44a and the hall-element signal-processing unit 45.

Information regarding the first coordinate of the detected position Pn in the x-direction, in other words the first detected position signal px, is input to the A/D converter A/D2 of the CPU 21 (refer to (2) in FIG. 6). The first detected position signal px is an analog signal that is converted to a digital signal by the A/D converter A/D2 (A/D conversion). Through the A/D conversion, analog px becomes digital pdxn.

Similarly, regarding the y-direction, pyl is input to the A/D converter A/D3 of the CPU 21, and pyr is input to the A/D converter A/D4 of the CPU 21. Through the A/D conversion, analog pyl becomes digital pdyln, and analog pyr becomes digital pdyrn.

The PID (Proportional Integral Differential) control procedure calculates the first, second, and third driving forces Dxn, Dyln, Dyrn on the basis of the coordinate data for the detected position Pn (pdxn, pdyln, pdyrn) and the position Sn (Sxn, Syln, Syrn) following movement.

The calculation of the first driving force Dxn is based on the first subtraction value exn, the first proportional coefficient Kx, the sampling cycle θ, the first integral coefficient Tix, and the first differential coefficient Tdx (Dxn=Kx×{exn+θ÷Tix×Σexn+Tdx÷θ×(exn−exn−1)}). The first subtraction value exn is calculated by subtracting the first coordinate of the detected position Pn in the x-direction after the A/D conversion, pdxn, from the coordinate of position Sn in the x-direction, Sxn (exn=Sxn−pdxn).

The calculation of the second driving force Dyn is based on the second subtraction value eyn, the second proportional coefficient Ky, the sampling cycle θ, the second integral coefficient Tiy, and the second differential coefficient Tdy (Dyn=Ky×{eyn+θ÷Tiy×Σeyn+Tdy÷θ×(eyn−eyn−1)}). The second subtraction value eyn is calculated by subtracting the second coordinate of the detected position Pn in the y-direction after the A/D conversion, pdyn, from the coordinate of position Sn in the y-direction, Syn (eyn=Syn−pdyn).

The value of the sampling cycle θ is set to the predetermined time interval of 1 ms (the second period).

The movable part 30a is driven to the position Sn (Sxn, Syn) by the anti-shake operation of the PID control procedure, when the photographing apparatus 1 is set to the anti-shake mode (IS=1) by the setting of the anti-shake switch 14a to the ON state. The position Sn is determined by the PID control procedure comprised in the anti-shake operation.

When the anti-shake parameter IS is zero, the PID control procedure not comprised in the anti-shake operation is performed so that the movable part 30a is moved to the center of the movement range (the predetermined position) In the dust-removal operation, from the point when the photographing apparatus 1 is set to the ON state until the anti-shake operation commences, the movable part 30a is first moved to the center of the movement range. After that, the movable part 30a is driven according to the processes described herein before.

The movable part 30a has a coil unit for driving that is comprised of a first driving coil 31a, a second driving coil 32a, a third driving coil 33a, an imaging unit 39a that has the image sensor, and a hall element 44a acting as a magnetic-field change-detecting element. In the first embodiment, the image sensor is a CCD; however, the image sensor may be another image sensor such as a CMOS, etc.

The rectangular form of the imaging surface of the image sensor has two sides parallel to the x-direction and two sides parallel to the y-direction that are shorter than those of the x-direction. Accordingly, the movement range of the movable part 30a in the x-direction is greater than in the y-direction.

The fixed part 30b has a magnetic unit for driving that is comprised of a first position-detecting and driving magnet 411b, a second position-detecting and driving magnet 412b, a third position-detecting and driving magnet 413b, a first position-detecting and driving yoke 431b, a second position-detecting and driving yoke 432b, and a third position-detecting and driving yoke 433b.

The fixed part 30b movably supports the movable part 30a in the x-direction and in the y-direction.

The fixed part 30b has a buffer member that absorbs the shock at the point of contact the movable part 30a (at the boundary of the movement range).

The hardness of the buffer member is chosen such that the part making contact, such as the movable part 30a, is not damaged by the shock of the impact, but any dust on the movable part 30a will be removed by the shock of the impact with the buffer member.

In the first embodiment, the buffer member is attached to the fixed part 30b; however, the buffer member may be attached to the movable part 30a.

When the movable part 30a is positioned at the center of its movement range in both the x-direction and the y-direction, the center of the image sensor intersects the optical axis LX of the camera lens 67, and the full imaging range of the image sensor may be utilized.

The rectangle shape, which is the form of the imaging surface of the image sensor, has two diagonal lines. In the first embodiment, the center of the image sensor is at the intersection of these two diagonal lines.

The first driving coil 31a, the second driving coil 32a, the third driving coil 33a, and the hall element 44a are attached to the movable part 30a.

The first driving coil 31a is formed in a sheet and a spiral and has magnetic field lines in the y-direction, thus creating the first electromagnetic force for moving the movable part 30a which includes the first driving coil 31a, in the x-direction.

The first electromagnetic force occurs on the basis of the current direction of the first driving coil 31a and the magnetic-field direction of the first position-detecting and driving magnet 411b.

The second and third driving coils 32a, 33a are formed in a sheet and a spiral and have magnetic field lines in the x-direction, thus creating the second electromagnetic force for moving the movable part 30a which includes the second and third driving coils 32a, 33a in the y-direction.

The second electromagnetic force occurs on the basis of the current direction of the second and third driving coil 32a, 33a and the magnetic-field direction of the second and third position-detecting and driving magnets 412b, 413b.

The first, second, and third driving coils 31a, 32a, and 33a are connected to the driver circuit 29 which drives the first, second, and third driving coils 31a, 32a, and 33a through a flexible circuit board (not depicted). The first PWM duty dx is input to the driver circuit 29 from the PWM0 of the CPU 21. Similarly, the second and third PWM duties dyl, dyr are input to the driver circuit 29 from the PWM1 and PWM2 of the CPU 21. The driver circuit 29 supplies power to the first driving coil 31a corresponding to the value of the first PWM duty dx, to the second driving coil 32a that corresponding to the value of the second PWM duty dyl, and to the third driving coil 33a that corresponding to the value of the third PWM duty dyr in order to drive the movable part 30a.

The first, second, and third position-detecting and driving yokes 431b, and, 432b, 433b are made of a soft, magnetic material, and provided on the fixed part 30b.

The first position-detecting and driving yoke 431b prevents the magnetic-field of the first position-detecting and driving magnet 411b from dissipating to the surroundings, and raises the magnetic-flux density between the first position-detecting and driving magnet 411b and the first driving coil 31a, and between the first position-detecting and driving magnet 411b and the horizontal hall element hh.

Similarly, the second and third position-detecting and driving yokes 432b, 433b prevents the magnetic-field of the second and third position-detecting and driving magnets 412b, 413b from dissipating to the surroundings, and raises the magnetic-flux densities between the second position-detecting and driving magnet 412b and the second driving coil 32a, between the second position-detecting and driving magnet 412b and the first vertical hall element hvl, between the third position-detecting and driving magnet 413b and the third driving coil 33a, and between the third position-detecting and driving magnet 413b and the second vertical hall element hvr.

The first position-detecting and driving magnet 411b is attached to the movable part side of the fixed part 30b, where the first position-detecting and driving magnet 411b faces the first driving coil 31a and the horizontal hall element hh in the z-direction. In detail, the first position-detecting and driving magnet 411b is attached to the first position-detecting and driving yoke 431b. The first position-detecting and driving yoke 431b is attached to the fixed part 30b on the side of the movable part 30a in the z-direction. The N pole and S pole of the first position-detecting and driving magnet 411b are arranged in the x-direction.

Similarly, the second and third position-detecting and driving magnets 412b, 413b are attached to the movable part side of the fixed part 30b, where the second and third position-detecting and driving magnets 412b, 413b face respectively the second and third driving coils 32a, 33a and the first and second vertical hall elements hvl, hvr in the z-direction. In detail, the second and third position-detecting and driving magnets 412b, 413b are attached to the second and third position-detecting and driving yokes 432b, 433b. The second and third position-detecting and driving yokes 432b, 433b are respectively attached to the fixed part 30b on the side of the movable part 30a in the z-direction. The N pole and S pole of the second and third position-detecting and driving magnets 412b, 413b are arranged in the y-direction.

The hall element 44a comprises a horizontal hall element hh which detects the coordinate of the position Pₙ of the movable part 30a in the x-direction, a first vertical hall element hvl which detects the coordinate of the XM-side of the movable part 30a in the y-direction, and a second vertical hall element hvr which detects the coordinate of the XP-side of the movable part 30a in the y-direction. Each hall element are single-axis units that contain magneto-electric converting elements (magnetic-field change-detecting elements) utilizing the Hall Effect. The horizontal hall element hh outputs the first detected position signal px which indicates the present position Pn of the movable part 30a. Similarly, the first and second vertical hall elements hvl, hvr respectively output the second and third detected position signals pyl, pyr.

The horizontal hall element hh is attached to the movable part 30a where the horizontal hall element hh faces the first position-detecting and driving magnet 411b in the z-direction. Similarly, the first and second vertical hall elements hvl, hvr are attached to the movable part 30a where they face the second and third position-detecting and driving magnets 412b, 413b in the z-direction.

When the center of the image sensor is intersecting the optical axis LX, it is desirable to have the horizontal hall element hh positioned on the hall element 44a facing an intermediate area between the N pole and S pole of the first position-detecting and driving magnet 411b in the x-direction, as viewed from the z-direction. In this position, the horizontal hall element hh utilizes the maximum range in which an accurate position-detecting operation can be performed based on the linear output change (linearity) of the single-axis hall element.

The hall-element signal-processing unit 45 has a first hall-element signal-processing circuit 450, a second hall-element signal-processing circuit 460, and a third hall-element signal-processing circuit 470.

The first hall-element signal-processing circuit 450 detects a horizontal potential difference x10 between the output terminals of the horizontal hall element hh that is based on an output signal of the horizontal hall element hh. The first hall-element signal-processing circuit 450 outputs the first detected position signal px, which specifies the first coordinate of the position Pn of the movable part 30a in the x-direction, to the A/D converter A/D2 of the CPU 21, on the basis of the horizontal potential difference x10.

Similarly, the second and third hall-element signal-processing circuits 460, 470 detect a left-side and right-side vertical potential differences y110, yr10 between the output terminals of the first and second vertical hall elements hvl, hvr that are based on an output signal of the vertical hall element hvl, hvr. After that, the second and third hall-element signal-processing circuits 460, 470 output the second and third detected position signals pyl, pyr to the A/D converters A/D3, A/D4 of the CPU 21.

Next, the main process of the photographing apparatus 1 in the first embodiment is explained using the flowchart of FIG. 4.

When the photographing apparatus 1 is set to the ON state, electrical power is supplied to the angular velocity detection unit 25 so that the angular velocity detection unit 25 is set to the ON state in step S11.

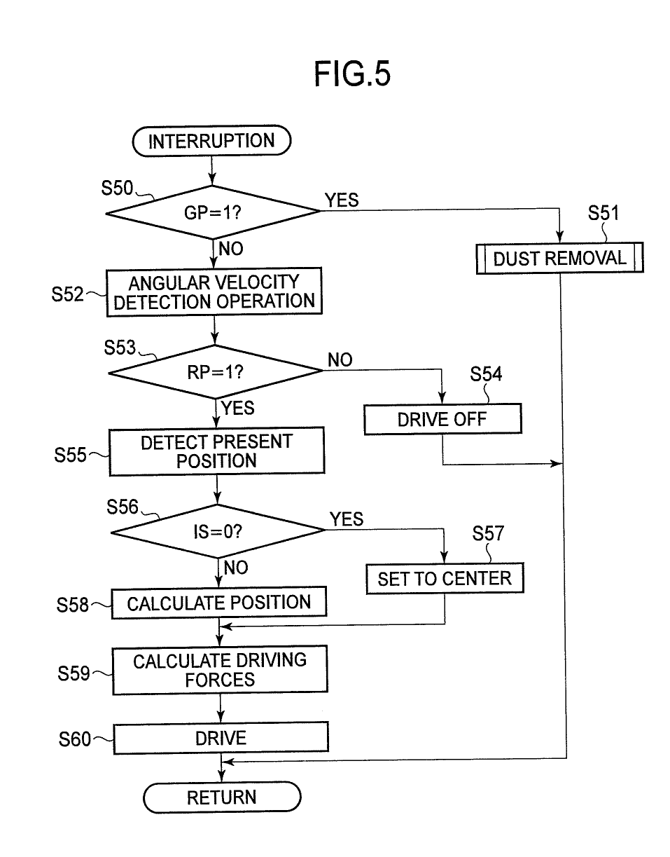

In step S12, the timer interruption process at the predetermined time interval (1 ms) commences. In step S13, the value of the release state parameter RP is set to zero. The detail of the timer interruption process is explained later using the flowchart of FIG. 5.

In step S14, the value of the dust-removal state parameter GP is set to one; the value of the dust-removal time parameter CNT is set to zero; and the channel parameter is set to a.

In step S15, it is determined whether the value of the dust-removal time parameter CNT is greater than 220 ms. Step S15 is provided to wait until the end of the timer interruption process. The dust-removal time parameter CNT is the time that is need so that the timer interruption process is finished. In this embodiment, in consideration of the completion time of the timer interruption process and individual differences in anti-shake units 30, 220 ms is used.

In step S15, it is determined whether the value of the dust-removal time parameter CNT is greater than 220 ms. When it is determined that the value of the dust-removal time parameter CNT is greater than 220 ms, the process continues to step S16; otherwise, the process in step S15 is repeated.

In step S16, the value of the dust-removal state parameter GP is set to 0.

In step S17, it is determined whether the photometric switch 12a is set to the ON state. When it is determined that the photometric switch 12a is set to the ON state, the process continues to step S18; otherwise, the process in step S17 is repeated.

In step S18, it is determined whether the anti-shake switch 14a is set to the ON state. When it is determined that the anti-shake switch 14a is not set to the ON state, the value of the anti-shake parameter IS is set to zero in step S19; otherwise, the value of the anti-shake parameter IS is set to one in step S20.

In step S21, the AE sensor of the AE unit 23 is driven, the photometric operation is performed, and the aperture value and exposure time are calculated.

In step S22, the AF sensor and the lens control circuit of the AF unit 24 are driven to perform the AF sensing and focusing operations, respectively.

In step S23, it is determined whether the release switch 13a is set to the ON state. When the release switch 13a is not set to the ON state, the process returns to step S17 and the process in steps S17 to S22 is repeated; otherwise, the process continues to step S24 and the release-sequence operation commences.

In step S24, the value of the release state parameter RP is set to one. In step S25, the mirror-up operation and the aperture closing operation corresponding to the aperture value that is either preset or calculated, are performed by the mirror-aperture-shutter unit 18.

After the mirror-up operation is finished, the opening operation of the shutter (the movement of the front curtain of the shutter) commences in step S26.

In step S27, the exposure operation, or in other words the electrical charge accumulation of the image sensor (CCD etc.), is performed. After the exposure time has elapsed, the closing operation of the shutter (the movement of the rear curtain of the shutter), the mirror-down operation, and the opening operation of the aperture are performed by the mirror-aperture-shutter unit 18 in step S28.

In step S29, the electrical charge which has accumulated in the image sensor during the exposure time is read. In step S30, the CPU 21 communicates with the DSP 19 so that the imaging process is performed based on the electrical charge read from the image sensor. The image, on which the image process is performed, is stored in the memory of the photographing apparatus 1. In step S31, the image that is stored in the memory is displayed on the LCD monitor 17. In step S32, the value of the release state parameter RP is set to zero, and the release sequence operation is finished. After that, the process then returns to step S17. In other words, the photographing apparatus 1 is set to a state where the next imaging operation can be performed.

Next, the timer interruption process, which commences in step S12 in FIG. 4 and is performed at every 1 ms time interval, is described with reference to the flowchart in FIG. 5.

When the timer interruption process commences, it is determined whether the value of the dust-removal state parameter GP is set to one in step S50. When it is determined that the value of the dust-removal state parameter GP is set to one, the process continues to step S51; otherwise, the process proceeds directly to step S52.

In step S51, the dust-removal process is performed. The detail of the dust-removal process is explained later using the flowchart of FIG. 6.

In step S52, the first angular velocity vx, which is output from the angular velocity detection unit 25, is input to the A/D converter A/D0 of the CPU 21 and converted to the first digital angular velocity signal Vxₙ. The second angular velocity vy, which is also output from the angular velocity detection unit 25, is input to the A/D converter A/D1 of the CPU 21 and converted to the second digital angular velocity signal Vyₙ (the angular velocity detection process).

The low frequencies of the first and second digital angular velocity signals Vxₙ and Vyₙ are reduced in the digital high-pass filter process (the first and second digital angular velocities VVxₙ and VVyₙ).

In step S53, it is determined whether the value of the release state parameter RP is set to one. When it is determined that the value of the release state parameter RP is not set to one, the driving control of the movable part 30a is set to the OFF state. In other words, the anti-shake unit 30 is set to a state where the driving control of the movable part 30a is not performed in step S54; otherwise, the process proceeds directly to step S55.

In step S55, the first, second, and third detected position signals px, pyr, and pyl are input to the CPU 21 thorough the A/D converters A/D2, A/D3, and A/D4, and also converted to digital signals. The CPU 21 determines the present position Pn (pdxn, pdyln, pdyrn) of the movable part 30a with the input signals.

In step S56, it is determined whether the value of the anti-shake parameter IS is zero. When it is determined that the value of the anti-shake parameter IS is zero, (in other words when the photographing apparatus is not in anti-shake mode), the position Sn (Sxn, Syn) where the movable part 30a (the imaging unit 39a) should be moved is set to the center of the movement range of the movable part 30a, in step S57. When it is determined that the value of the anti-shake parameter IS is not zero (IS=1), (in other words when the photographing apparatus is in anti-shake mode), the position Sn (Sxn, Syn) where the movable part 30a (the imaging unit 39a) should be moved is calculated on the basis of the first and second angular velocities vx and vy, in step S58.

In step S59, the first driving force Dxn (the first PWM duty dx), the second driving force Dyln (the second PWM duty dyl), and the third driving force Dyrn (the third PWM duty dyr) of the driving force Dn that moves the movable part 30a to the position Sn are calculated on the basis of the position Sn (Sxn, Syn) that was determined in step S57 or step S58, and the present position Pn (pdxn, pdyln, pdyrn). In the dust-removal operation, the second driving force Dyln (the second PWM duty dyl) and the third driving force Dyrn (the third PWM duty dyr) are opposite in sign and have the same absolute value.

In step S60, the first driving coil unit 31a is driven by applying the first PWM duty dx to the driver circuit 29, and the second and third driving coil units 32a, 33a are driven by applying the second and third PWM duties dyl, dyr to the driver circuit 29, so that the movable part 30a is moved to position Sn (Sxn, Syn).

The process of steps S59 and S60 is an automatic control calculation that is used with the PID automatic control for performing general proportional, integral, and differential calculations.

Next, the dust-removal process, which commences in step S51 in FIG. 5, is explained using the flowchart in FIGS. 6 to 9.

When the dust-removal process commences, the value of the dust-removal time parameter CNT is increased by one in step S701.

In step S702, the hall element 44a detects the position of the movable part 30a, and the first, second, and third detected position signals px, pyl, and pyr are calculated by the hall-element signal-processing unit 45. The first detected position signal px is then input to the A/D converter A/D2 of the CPU 21 and converted to a digital signal pdxn, whereas the second and third detected position signals pyl, pyr are input to the A/D converters A/D3 and AD/4 of the CPU 21 and also converted to digital signals, whereupon the CPU 21 determines the present position Pn (pdxₙ, pdylₙ, pdyrₙ) of the movable part 30a with the input signals.

In step S703, it is determined whether the value of the dust-removal time parameter CNT is less than or equal to 65 ms. In the case that the value of the dust-removal time parameter CNT is less than or equal to 65 ms, step S704 to S706 are commenced. In the case that the value of the dust-removal time parameter CNT is not less than or equal to 65 ms, the process proceeds to step S710.

Steps S704 to S706 process the “a” trajectory which drives the movable part 30a to the center of the fixed part 30b. FIG. 9(a) illustrates the position of the fixed part 30a after executing the “a” trajectory.

In the step S704, the position Sn (Sxn, Syn) where the movable part 30a (the imaging unit 39a) should be moved is set to the center of the movement range of the movable part 30a.

In step S705, the driving force Dn that moves the movable part 30a is calculated using the position Sn (Sxn, Syn) that was determined in step S704 according to the present position Pn (pdxn, pdyn). This calculation is the same as the one in step S59 in the timer interruption process.

In step S706, the movable part 30a is moved by executing the same process as in step S60 in the timer interruption process. Then, the dust-removal process ends, and the process returns to the timer interruption process (subroutine return).

The timer interruption process is executed once every millisecond (the second periods). Therefore, the dust-removal process is also repeatedly executed until the dust-removal state parameter GP is set to zero in step S16 of the main process.

When the dust-removal process commences again, the value of the dust-removal time parameter CNT is increased by one, making it two, in step S701. Then, steps S702 and S703 are executed. In step S703, it is determined whether the value of the dust-removal time parameter CNT is less than or equal to 65 ms. At this point, the value of the dust-removal time parameter CNT is two. Therefore, the process proceeds to step S704, and then, ends after performing steps S704 to S706 (subroutine return). After that, the dust-removal process is executed again in the timer interruption process.

Steps S701 to S706 are repeatedly executed until the dust-removal time parameter CNT exceeds 65 ms. In the case that the dust-removal time parameter CNT exceeds 65 ms in step S703, the process proceeds to step S710. Note that the movable part 30a is placed in the center of the fixed part 30b.

The maximum time interval which is needed to move the movable part 30a from the present position to the center of the fixed part 30b is 65 ms. In other words, the time interval calculated by adding the average time interval which is needed to move the movable part 30a from the corner to the center of the fixed part 30b and the error time interval due to individual differences in anti-shake units 30 is 65 ms. Therefore, the threshold value of the dust-removal time parameter CNT is set to 65 ms. In the case the dust-removal time parameter CNT is less than or equal to 65 ms, there is a possibility that movable part 30a will not yet have been centered within the fixed part 30b. In the case the dust-removal time parameter CNT is greater than 65 ms, the movable part 30a will be in the center of fixed part 30b.

In step S710, it is determined whether the dust-removal time parameter CNT is less than or equal to 115 ms. In the case that the dust-removal time parameter CNT is less than or equal to 115 ms, steps S711 to S715 is commenced. In the case that the dust-removal time parameter CNT is not less than or equal to 115 ms, the process proceeds to step S720.

The process of steps S711 to S715 is described. Steps S711 to S715 process the “b” trajectory which strikes the XP-end of the YP-side of the movable part 30a against the upper boundary 34a of the fixed part 30b and the XM-end of the YM-side of the movable part 30a strikes the lower boundary 34b of the fixed part 30b. FIG. 9(b) illustrates the movable part 30a after processing the “b” trajectory.

In step S711, the value of the second PWM duty dyl is set to −DD. In step S712, the value of the third PWM duty dyr is set to DD. The value DD, i.e., the absolute value |+DD| and |−DD| is set so that the acceleration of the movable part 30a when it strikes the boundary of its movement range is increased to the degree at which the dust on the movable part 30a can be removed by the shock of the impact.

In step S713, the coordinate of position Sn in the x-direction, Sxn, where the movable part 30a should be moved in the x-direction, is set to the center of the movement range of the movable part 30a in the x-direction.

In step S714, the first driving force Dxn (the first PWM duty dx) is calculated on the basis of the coordinate of position Sn in the x-direction, Sxn, determined in step S713, and the coordinate of the present position Pn in the x-direction, pdxn. The first driving force Dxn, i.e., the driving force Dn which moves the movable part 30a in the x-direction, is needed to move the movable part 30a by providing currents to the first driving coil unit 31a.

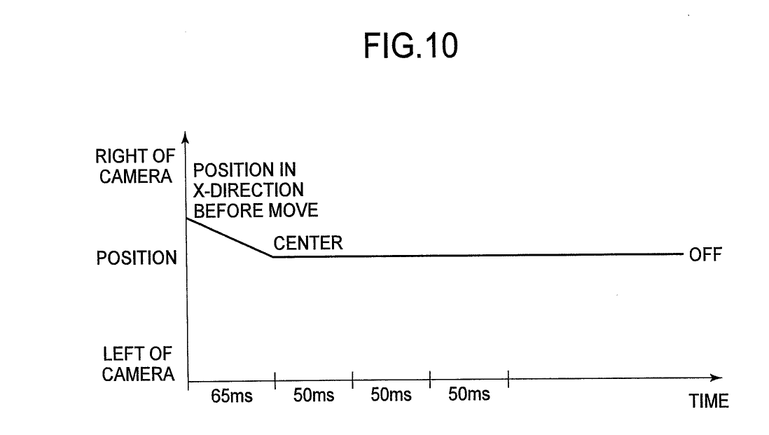

In step S715, the first, second, and third driving coil units 31a, 32a, and 33a are respectively driven by applying the first, second, and third PWM duties dx, dyl, and dyr to the driver circuit 29, so that the movable part 30a is moved. The movable part 30a is moved towards the center of the movable range along the x-direction, and fixed at the center of the movable range along the x-direction (refer to FIG. 10). Additionally, the XP-side of the movable part 30a is moved towards the top of the fixed part 30b, i.e., along the positive y-direction. The XM-side of the movable part 30a is moved towards the bottom of the fixed part 30b, i.e., along the negative y-direction. Therefore, the movable part 30a rotates counterclockwise relative to the axis perpendicular to the imaging surface and passing through the center of mass of the movable part 30a. After that, the process ends (subroutine return), and the dust-removal process is executed again in the timer interruption process.

When the dust-removal process commences again, the value of the dust-removal time parameter CNT is increased by one so as to become 67, in step S701. Then, steps S702, S703, and S710 to S715 are executed. Thus, steps S701 to S703, and S701 to S715 are executed until the value of the dust-removal time parameter CNT exceeds 115 ms. In the case that the value of the dust-removal time parameter CNT is larger than 115 ms in step S710, the process proceeds to step S720.

By iterating steps S701 to S715, the movable part 30a is fixed so as to contact the bottom side of the fixed part 30b after the XM-side of the movable part 30a strikes the bottom side of the fixed part 30b, and so as to contact the top side of the fixed part 30b after the XP-side of the movable part 30a strikes the top side of the fixed part 30b (refer to FIG. 9(b)).

Hereinafter is described the reason why the threshold value of the dust-removal time parameter CNT is set to 115 ms. The maximum time interval, from the moment that the movable part 30a starts moving from the center of the fixed part 30b to the moment that the bounce from the collision is settled, is 50 ms. Specifically, the maximum time interval calculated by adding: the average time interval from the moment that the movable part 30a starts moving from the center of the fixed part 30b to the moment that it arrives at the top or bottom of the fixed part 30b; the error time interval of the individual difference of the anti-shake unit 30; and the time interval that the bounce from the collision takes to settle, is 50 ms. The threshold value 115 ms is calculated by adding the maximum time interval 50 ms and the time interval from the moment that the dust-removal process starts to the moment that the “b” trajectory is started. In the case the dust-removal time parameter CNT is less than or equal to 115 ms, there is a possibility that movable part 30a has not yet arrived at the top or bottom of fixed part 30b. In the case the dust-removal time parameter CNT is greater than 115 ms, the movable part 30a should be at the top or bottom of fixed part 30b.

In the next step, S720, it is determined whether the dust-removal time parameter CNT is less than or equal to 165 ms. In the case that the dust-removal time parameter CNT is less than or equal to 165 ms, steps S721 to S722, and S713 to S715 are commenced. In the case that the dust-removal time parameter CNT is not less than or equal to 165 ms, the process proceeds to step S730.

Next, the process of steps S721, S722, and S713 to S715 is described. These steps process the “c” trajectory which strikes the XM-end of the YP-side of the movable part 30a against the upper boundary 34a of the fixed part 30b and the XP-end of the YM-side of the movable part 30a strikes the lower boundary 34b of the fixed part 30b. FIG. 9(c) illustrates the movable part 30a after processing the “c” trajectory.

In step S721, the value of the second PWM duty dyl is set to +DD. In step S722, the value of the third PWM duty dyr is set to −DD.

Processes similar to those described above commence in steps S713 to S715, so that the movable part 30a is returned to the center of the movable range along the x-direction (refer to FIG. 10). Additionally, the XP-side of the movable part 30a is moved towards the bottom of the fixed part 30b, i.e., along the negative y-direction, the XM-side of the movable part 30a is moved towards the top of the fixed part 30b, i.e., along the positive y-direction. Therefore, the movable part 30a rotates clockwise relative to the axis perpendicular to the imaging surface and passing through the center of mass of the movable part 30a. After that, the process ends (subroutine return), and the dust-removal process is executed again in the timer interruption process.

When the dust-removal process commences again, the value of the dust-removal time parameter CNT is increased by one so as to become 117 ms, in step S701. Then, steps S702, S703, S710, S720, S721, S722, and S713 to S715 are executed. Thus, these steps are iterated until the value of the dust-removal time parameter CNT is greater than 165 ms. In the case that the value of the dust-removal time parameter CNT is greater than 165 ms in step S720, the process proceeds to step S730.

By executing these steps, the movable part 30a is fixed so as to contact the top side of the fixed part 30b after the XM-side of the movable part 30a strikes the top side of the fixed part 30b, and so as to contact the bottom side of the fixed part 30b after the XP-side of the movable part 30a strikes the bottom side of the fixed part 30b (refer to FIG. 9(c)).

The reason why the dust-removal time parameter CNT is set to 165 ms is omitted because÷it was described above. In the case the dust-removal time parameter CNT is less than or equal to 165 ms, there is a possibility that movable part 30a has not yet arrived at the top or bottom of fixed part 30b. In the case the dust-removal time parameter CNT is greater than 165 ms, the movable part 30a is fixed so as to contact the top or bottom of fixed part 30b.

In next step S730, it is determined whether the dust-removal time parameter CNT is less than or equal to 215 ms. In the case that the dust-removal time parameter CNT is less than or equal to 215 ms, steps S731 to S732 and S713 to S715 are commenced. In the case that the dust-removal time parameter CNT is not less than or equal to 215 ms, the process proceeds to step S740.

The descriptions concerning steps S731 and S732 and steps S713 and S715 are omitted because steps S731 and S732 are similar to steps S711 and S721 and steps S713 and S715 are described above. Steps S731, S732, and S713 to S715 process the “d” trajectory which strikes the XP-end of the YP-side of the movable part 30a against the upper boundary 34a of the fixed part 30b and the XM-end of the YM-side of the movable part 30a strikes the lower boundary 34b of the fixed part 30b.

By executing these steps, the movable part 30a is fixed so as to contact the bottom side of the fixed part 30b after the XM-side of the movable part 30a strikes the bottom side of the fixed part 30b, and so as to contact the top side of the fixed part 30b after the XP-side of the movable part 30a strikes the top side of the fixed part 30b (refer to FIG. 9(d)).

The reason why the dust-removal time parameter CNT is set to 215 ms is omitted because it was described above. In the case the dust-removal time parameter CNT is less than or equal to 215 ms, there is a possibility that movable part 30a has not yet arrived at the top or bottom of fixed part 30b. In the case the dust-removal time parameter CNT is greater than 215 ms, the movable part 30a is fixed so as to contact the top or bottom of fixed part 30b.

In the next step S740, the movable part 30a is in the drive OFF state. Therefore, driving force is not applied to the movable part 30a, so that the movable part 30a settles at the bottom of the fixed part 30b by gravity (refer to FIG. 9(e)).

According to this embodiment, one end of the movable part 30a is moved in the positive y-direction while the other end is moved in the negative y-direction. This results in a cancellation of momentum, thereby reducing shock in the drive device.

Note that the impact of the movable part 30a and the fixed part 30b is not limited to three times, but may be any number of times greater than or equal to one. In that case, steps S710 to S715, or steps S720 to S722 and S713 to S715 are executed according to the number of impacts.

In the dust-removal operation, the movable part 30a may be held at the center in the y-direction and moved in the x-direction. The movable range of the movable part 30a in the x-direction is larger than in the y-direction.

Furthermore, the position to which the movable part 30a is moved when the dust-removal operation commences is not limited to the center of the movement range of the movable part 30a. It may be any position where the movable part 30a does not make contact with the boundary of the movement range of the movable part 30a.

Moreover, it is explained that the hall element is used for position detection as the magnetic-field change-detecting element. However, another detection element, an MI (Magnetic Impedance) sensor such as a high-frequency carrier-type magnetic-field sensor; a magnetic resonance-type magnetic-field detecting element; or an MR (Magneto-Resistance effect) element may be used for position detection purposes. When one of either the MI sensor, the magnetic resonance-type magnetic-field detecting element, or the MR element is used, the information regarding the position of the movable part 30a can be obtained by detecting the magnetic-field change, similar to using the hall element.

Although the embodiment of the present invention has been described herein with reference to the accompanying drawings, obviously many modifications and changes may be made by those skilled in the art without departing from the scope of the invention.

The present disclosure relates to subject matter contained in Japanese Patent Application No. 2008-056206 (filed on Mar. 6, 2008), which is expressly incorporated herein, by reference, in its entirety.

1. A drive device comprising:
a movable part that is swingable relative to a fixed part;
a first drive part that drives said movable part in a first direction; and
a second drive part that drives said movable part in a direction opposite to the first direction;
said fixed part having bumpers which are struck by said movable part;
said first and second drive parts simultaneously driving said movable part so as to strike the bumpers.

2. The drive device according to claim 1, wherein said movable part is divided into a first portion and a second portion by a surface which is parallel to the first direction and passes through the center of mass of said movable part;
wherein said first drive part applies force on the first portion, and said second drive part applies force on the second portion.

3. The drive device according to claim 1 further comprising a third drive part that fixes said movable part relative to said fixed part so that said movable part does not move in a second direction, and is isolated from the first direction, wherein said third drive part holds said movable part when said first and second drive parts drive said movable part.

4. The drive device according to claim 1, wherein said first and second drive parts move said movable part so as to reciprocate along the first direction.

5. An image-capturing device comprising:
a drive device having a movable part that is swingable relative to a fixed part, a first drive part that drives said movable part in a first direction, and a second drive part that drives said movable part in a direction opposite the first direction, said fixed part having bumpers which are struck by said movable part, said first and second drive parts driving said movable part so as to strike the bumpers simultaneously; and
said fixed part holding an imaging sensor.

6. The image-capturing device according to claim 5, wherein said drive part may drive said movable part in a second direction, isolated from the first direction on the imaging surface of the imaging sensor, and wherein said drive part is a shake-correction part which corrects the shake of said image sensor by driving said movable part in the first and second directions within a shake-correction area,
wherein said fixed part is provided outside the shake-correction area, and
wherein said movable part strikes said fixed part beyond the shake-correction area.

7. The image-capturing device according to claim 5, wherein said first and second drive parts driving said movable part so as to holds the center of the movement range of said movable part before said first and second drive parts simultaneously driving said movable part so as to strike the bumpers.

8. The image-capturing device according to claim 5, wherein an imaging area of the imaging sensor is covered by a covering part.
